(19) United States
(12) Patent Application Publication
(10) Pub. No.: US 2021/0234588 A1
(43) Pub. Date: Jul. 29, 2021

(54) PROCESSING METHOD AND APPARATUS BASED ON UPLINK SIGNAL, RELATED DEVICE, AND STORAGE MEDIUM

(71) Applicants: CHINA MOBILE COMMUNICATION CO., LTD RESEARCH INSTITUTE, Beijing (CN); CHINA MOBILE COMMUNICATIONS GROUP CO., LTD., Beijing (CN)

(72) Inventors: Yan LI, Beijing (CN); Fei WANG, Beijing (CN); Xueying HOU, Beijing (CN); Yi ZHENG, Beijing (CN)

(73) Assignees: CHINA MOBILE COMMUNICATION CO., LTD RESEARCH INSTITUTE, Beijing (CN); CHINA MOBILE COMMUNICATIONS GROUP CO., LTD., Beijing (CN)

(21) Appl. No.: 17/050,811

(22) PCT Filed: May 5, 2019
(86) PCT No.: PCT/CN2019/085579

§ 371 Date: Oct. 26, 2020

(30) Foreign Application Priority Data
May 11, 2018 (CN) 201810446930.8

(51) Int. Cl. H04B 7/06; H04L 25/02; H04L 5/00; H04W 72/04

(52) U.S. Cl. CPC H04B 7/0604; H04L 25/0226; H04W 72/042; H04W 72/0446; H04L 5/0051

(57) ABSTRACT

A processing method based on an uplink signal includes: a network device configures two non-periodic sounding reference signal (SRS) resource sets for a terminal for antenna switching.

### CROSS-REFERENCE TO RELATED APPLICATION

The present application is based on and claims priority to Chinese Patent Application No. 201810446930.8, filed on May 11, 2018, the disclosure of which is hereby incorporated by reference in its entirety.

### TECHNICAL FIELD

The disclosure relates to the field of wireless communications, and particularly to an uplink-signal-based processing method and apparatus, a related device and a storage medium.

### BACKGROUND

In a communication system, a base station estimates uplink channel quality for different bands using a sounding reference signal (SRS).

SRSs may be divided into two types, i.e., periodic and semi-persistent SRSs and aperiodic SRSs respectively. However, when aperiodic SRSs are used for antenna switching, a guard interval of at least one symbol is required to be reserved between the aperiodic SRSs, and the aperiodic SRSs may be transmitted on last six symbols of each slot only, so that it is impossible to complete transmission of multiple aperiodic SRSs for antenna switching in a slot. That is, for transmission of aperiodic SRS s for antenna switching, there is yet no solution at present.

### SUMMARY

For solving related technical problems, embodiments of the disclosure provide an uplink-signal-based processing method and apparatus, a related device and a storage medium.

The technical solutions of the embodiments of the disclosure are implemented as follows.

The embodiments of the disclosure provide an uplink-signal-based processing method, which is applied to a network device and includes the following operation.

Two aperiodic SRS resource sets for antenna switching are configured for a terminal.

In the solution, the two aperiodic SRS resource sets may include totally four SRS resources, the four SRS resources may be transmitted in different orthogonal frequency division multiplexing (OFDM) symbols of two different slots, a SRS port of each SRS resource in the two aperiodic SRS resource sets being associated with a different antenna port of the terminal.

In the solution, during configuring the two aperiodic SRS resource sets, the method may further include at least one of the following operations:

the two aperiodic SRS resource sets are both configured with same values of higher layer parameter aperiodicSRS-ResourceTrigger; or

the two aperiodic SRS resource sets are configured with different values of higher layer parameter slotoffset.

In the solution, the two aperiodic SRS resource sets may be triggered by a piece of downlink control information (DCI).

In the solution, the two aperiodic SRS resource sets may be triggered by two pieces of DCI, respectively.

In the solution, during configuring the two aperiodic SRS resource sets, the method may further include the following operation.

Each of the two aperiodic SRS resource sets is configured with two SRS resources.

In the solution, during configuring the two aperiodic SRS resource sets, the method may further include the following operation.

One of the two aperiodic SRS resource sets is configured with one SRS resource, and the other of the two aperiodic SRS resource sets is configured with three SRS resources.

In the solution, when higher layer parameters Usage of the two aperiodic SRS resource sets are set to be antenna switching, the two aperiodic SRS resource sets may be configured for four-port antenna switching.

The embodiments of the disclosure also provide an uplink-signal-based processing method, which is applied to a terminal and includes the following operation.

Antenna switching is performed using two aperiodic SRS resource sets.

In the solution, during performing the antenna switching, the method may further include that: it is determined that triggered SRS resource sets are the two aperiodic SRS resource sets based on at least one of the following:

two same values of higher layer parameter aperiodicSRS-ResourceTrigger; or

two different values of higher layer parameter slotoffset.

In the solution, the method may further include the following operation.

It is determined that the triggered SRS resource sets are the two aperiodic SRS resource sets based on a piece of received DCI.

In the solution, the method may further include the following operation.

It is determined that a triggered SRS resource set is one of the two aperiodic SRS resource sets based on one piece of DCI in two pieces of received DCI, and it is determined that another triggered SRS resource set is the other of the two aperiodic SRS resource sets based on the other DCI in the two pieces of received DCI.

In the solution, when higher layer parameters Usage of the two aperiodic SRS resource sets are set to be antenna switching, it may be determined that the triggered aperiodic SRS resource sets are configured for four-port antenna switching.

The embodiments of the disclosure also provide an uplink-signal-based processing apparatus, which may include a configuration unit.

The configuration unit may be configured to configure for a terminal two aperiodic SRS resource sets for antenna switching.

In the solution, the configuration unit may further be configured to execute at least one of the following operations:

configuring the two aperiodic SRS resource sets with same values of higher layer parameter aperiodicSRS-ResourceTrigger; or

configuring the two aperiodic SRS resource sets with different values of higher layer parameter slotoffset.

In the solution, the configuration unit may further be configured to:

configure each of the two aperiodic SRS resource sets with two SRS resources.

In the solution, the configuration unit may further be configured to:

configure one of the two aperiodic SRS resource sets with one SRS resource and configure the other of the two aperiodic SRS resource sets with three SRS resources.

The embodiments of the disclosure also provide an uplink-signal-based processing apparatus, which may include a transmission unit.

The transmission unit may be configured to perform antenna switching using two aperiodic SRS resource sets.

In the solution, the transmission unit may further be configured to determine that triggered SRS resource sets are the two aperiodic SRS resource sets based on at least one of the following:

two same values of higher layer parameter aperiodicSRS-ResourceTrigger; or

two different values of higher layer parameter slotoffset.

In the solution, the transmission unit may further be configured to:

when higher layer parameters Usage of the two aperiodic SRS resource sets are set to be antenna switching, determine that the triggered aperiodic SRS resource sets are configured for four-port antenna switching.

The embodiments of the disclosure also provide a network device, which may include:

a first communication interface; and

a first processor, configured to, through the first communication interface, configure two aperiodic SRS resource sets for antenna switching for a terminal.

In the solution, the first processor may further be configured to execute, through the first communication interface, at least one of the following operations:

configuring the two aperiodic SRS resource sets with same values of higher layer parameter aperiodicSRS-ResourceTrigger; or

configuring the two aperiodic SRS resource sets with different values of higher layer parameter slotoffset.

In the solution, the first processor may further be configured to, through the first communication interface, configure each of the two aperiodic SRS resource sets with two SRS resources.

In the solution, the first processor unit may further be configured to:

through the first communication interface, configure one of the two aperiodic SRS resource sets with one SRS resource and configure the other of the two aperiodic SRS resource sets with three SRS resources.

The embodiments of the disclosure also provide a terminal, which may include:

a second communication interface; and

a second processor, configured to perform, through the second communication interface, antenna switching using two aperiodic SRS resource sets.

In the solution, the second processor may further be configured to determine that triggered SRS resource sets are the two aperiodic SRS resource sets based on at least one of the following:

two same values of higher layer parameter aperiodicSRS-ResourceTrigger; or

two different values of higher layer parameter slotoffset.

In the solution, the second processor unit may further be configured to:

when higher layer parameters Usage of the two aperiodic SRS resource sets are set to be antenna switching, determine that the triggered aperiodic SRS resource sets are configured for four-port antenna switching.

The embodiments of the disclosure also provide a network device, which may include a first processor and a first memory configured to store a computer program capable of running in the first processor.

The first processor may be configured to run the computer program to execute the steps of any method for a network device side.

The embodiments of the disclosure also provide a terminal, which may include a second processor and a second memory configured to store a computer program capable of running in the second processor.

The second processor may be configured to run the computer program to execute the steps of any method for a terminal side.

The embodiments of the disclosure also provide a storage medium, in which a computer program may be stored, the computer program being executed by a processor to perform any method for a network device side or perform any method for a terminal side.

According to the uplink-signal-based processing method and apparatus, related device and storage medium provided in the embodiments of the disclosure, the network device configures the two aperiodic SRS resource sets for antenna switching for the terminal, and the terminal performs antenna switching using the two aperiodic SRS resource sets. Considering that a guard interval of at least one symbol is required to be reserved between aperiodic SRSs for antenna switching, for the aperiodic SRSs for antenna switching, the two aperiodic SRS resource sets are configured for the terminal to enable the terminal to transmit the aperiodic SRSs using the two aperiodic SRS resource sets, so that transmission of the aperiodic SRSs for antenna switching is implemented.

### BRIEF DESCRIPTION OF THE DRAWINGS

FIG. 1 is a flowchart of an uplink-signal-based processing method for a network device side according to an embodiment of the disclosure.

FIG. 2 is a flowchart of an uplink-signal-based processing method for a terminal side according to an embodiment of the disclosure.

FIG. 3 is a flowchart of an uplink-signal-based processing method according to an embodiment of the disclosure.

FIG. 4 is a structure diagram of an uplink-signal-based processing apparatus according to an embodiment of the disclosure.

FIG. 5 is a structure diagram of another uplink-signal-based processing apparatus according to an embodiment of the disclosure.

FIG. 6 is a structure diagram of a network device according to an embodiment of the disclosure.

FIG. 7 is a structure diagram of a terminal according to an embodiment of the disclosure.

FIG. 8 is a structure diagram of an uplink-signal-based processing system according to an embodiment of the disclosure.

### DETAILED DESCRIPTION

The disclosure will further be described below in combination with the drawings and embodiments in detail.

When aperiodic SRSs are used for antenna switching, it is impossible to transmit the aperiodic SRSs in a slot, and this is mainly because a guard interval of at least one symbol is required to be reserved between the aperiodic SRSs and the aperiodic SRSs can be transmitted on last six symbols of each slot only. Therefore, it is impossible to complete transmission of multiple aperiodic SRSs for antenna switching in a slot.

For example, for aperiodic SRSs for 1-Transmit 4-Receive (1T4R) antenna switching, four SRS resources are required to correspond to four antenna ports, respectively. As shown in Table 1, during SRS antenna switching, a guard interval is required to be reserved between two SRS resources. Therefore, for 1T4R antenna switching, at least seven symbols are required to transmit SRS resources. However, SRS s can only be transmitted on last six uplink symbols of each slot, so that it is impossible to complete transmission of the SRSs requiring seven symbols for 1T4R antenna switching in a slot.

TABLE 1

| μ | Δf = 2^{μ} · 15 [kHz] | Guard interval |
|---|---|---|
| 0 | 15 | 1 |
| 1 | 30 | 1 |
| 2 | 60 | 1 |
| 3 | 120 | 2 |

Based on this, in various embodiments of the disclosure, when aperiodic SRSs are used for antenna switching, two aperiodic SRS resource sets for antenna switching are configured for a terminal, and four SRS resources in the two aperiodic SRS resource sets may be associated with four different antenna ports of the terminal respectively.

According to the solutions of the embodiments of the disclosure, considering a guard interval between aperiodic SRSs, for the aperiodic SRSs for antenna switching, the two aperiodic SRS resource sets (the SRS resource set may be called an SRS resource set) are configured for the terminal, so that the terminal can transmit the aperiodic SRSs using the two aperiodic SRS resource sets, thereby realizing transmission of the aperiodic SRSs for antenna switching.

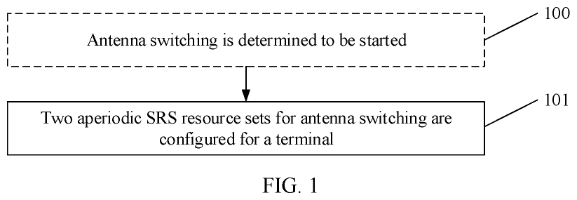

The embodiments of the disclosure provide an uplink-signal-based processing method, which is applied to a network device, specifically a base station. In a 5th-generation (5G) system, a base station is called a next-generation Node B (gNB). As illustrated in FIG. 1, the method includes the following operations.

In 100, antenna switching is determined to be started.

Herein, antenna switching may be determined to be started based on a setting of a higher layer parameter. For example, when the higher layer parameter Usage is set to be “antenna switching”, antenna switching is determined to be started.

In 101, two aperiodic SRS resource sets for antenna switching are configured for a terminal.

In an embodiment, the two aperiodic SRS resource sets include totally four SRS resources, the four SRS resources are transmitted on different OFDM symbols of two different slots, each SRS resource in the two aperiodic SRS resource sets includes one SRS port, and the SRS port of each SRS resource is associated with a different antenna port of the terminal.

In an implementation, the two aperiodic SRS resource sets may be triggered by a piece of DCI for transmission.

In such case, during configuring the two aperiodic SRS resource sets, the method may further include at least one of the following operations:

configuring the two aperiodic SRS resource sets with same values of higher layer parameter aperiodicSRS-ResourceTrigger; or

configuring the two aperiodic SRS resource sets with different values of higher layer parameter slotoffset.

An aperiodicSRS-ResourceTrigger parameter indicates aperiodic SRS resource sets triggered by the DCI, and a slotoffset parameter indicates that transmission of an aperiodic SRS is started after an interval of slots in a number equal to the slotoffset after triggering of the DCI.

That is, the terminal may determine that the triggered SRS resource sets are the two aperiodic SRS resource sets based on at least one of the following:

two same values of higher layer parameter aperiodicSRS-ResourceTrigger; or

two different values of higher layer parameter slotoffset.

In another implementation, the two aperiodic SRS resource sets may be triggered by two pieces of DCI for transmission, respectively.

In an embodiment, antenna switching may be 1T4R antenna (four-port antenna) switching. That is, the aperiodic SRSs for antenna switching are aperiodic SRSs for 1T4R antenna switching.

Only when the higher layer parameters Usage of both the two aperiodic SRS resource sets are set to be antenna switching, the two aperiodic SRS resource sets are used for four-port antenna switching.

During a practical application, the numbers of the SRS resources in the two aperiodic SRS resource sets may be configured in the following two manners.

A first manner: each of the two aperiodic SRS resource sets is configured with two SRS resources.

A second manner: one of the two aperiodic SRS resource sets is configured with one SRS resource, and the other of the two aperiodic SRS resource sets is configured with three SRS resources.

During the practical application, one of the abovementioned manners may be selected as required.

After the configuration is completed, the network device may transmit configuration information to the terminal so that the terminal can perform the transmission of aperiodic SRSs.

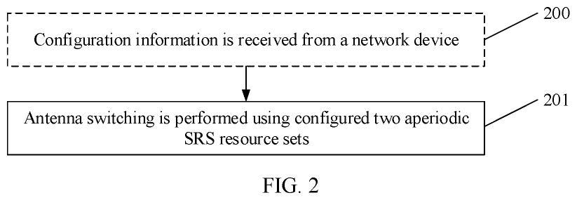

Correspondingly, the embodiments of the disclosure also provide an uplink-signal-based processing method, which is applied to a terminal. As illustrated in FIG. 2, the method includes the following operations.

In 200, configuration information is received from a network device.

In 201, antenna switching is performed using configured two aperiodic SRS resource sets.

In other words, aperiodic SRSs for antenna switching are transmitted using the two aperiodic SRS resource sets.

In an implementation, the two aperiodic SRS resource sets may be triggered by a piece of DCI for transmission.

Based on this, during performing the antenna switching, the terminal determines that triggered SRS resource sets are the two aperiodic SRS resource sets based on a piece of received DCI.

In such case, the terminal determines that the triggered SRS resource sets are the two aperiodic SRS resource sets based on at least one of the following:

two same values of higher layer parameter aperiodicSRS-ResourceTrigger; or

two different values of higher layer parameter slotoffset.

In another implementation, the two aperiodic SRS resource sets may be triggered by two pieces of DCI for transmission, respectively.

Based on this, during performing antenna switching, the terminal determines, based on one piece of DCI in two pieces of received DCI, that a SRS resource set triggered by the piece of DCI is one aperiodic SRS resource set in the two aperiodic SRS resource sets, and determines, based on the other of the two pieces of received DCI, that a SRS resource set triggered by the other piece of the DCI is the other aperiodic SRS resource set in the two aperiodic SRS resource sets.

In an implementation, antenna switching may be 1T4R antenna (four-port antenna) switching. That is, the aperiodic SRSs for antenna switching are aperiodic SRSs for 1T4R antenna switching.

Only when higher layer parameters Usage of both the two aperiodic SRS resource sets are set to be antenna switching, the two aperiodic SRS resource sets are used for four-port antenna switching.

Based on this, when the higher layer parameters Usage of both the two aperiodic SRS resource sets are set to be antenna switching, the terminal determines that the triggered aperiodic SRS resource sets are used for four-port antenna switching.

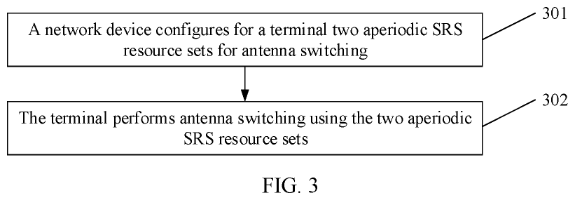

The embodiments of the disclosure also provide an uplink-signal-based processing method. As illustrated in FIG. 3, the method includes the following operations.

In 301, a network device configures two aperiodic SRS resource sets for antenna switching for a terminal.

In 302, the terminal performs antenna switching using the two aperiodic SRS resource sets.

It is to be noted that specific processing processes of the network device and the terminal are elaborated above and will not be elaborated herein.

According to the methods provided in the embodiments of the disclosure, the network device configures the two aperiodic SRS resource sets for antenna switching of the terminal, and the terminal performs antenna switching using the two aperiodic SRS resource sets. Considering a guard interval between aperiodic SRSs, for the aperiodic SRSs for antenna switching, the two aperiodic SRS resource sets are configured for the terminal to enable the terminal to transmit the aperiodic SRSs through the two aperiodic SRS resource sets, so that transmission of the aperiodic SRSs for antenna switching is implemented.

In addition, other parameters for indicating the two aperiodic SRS resource sets are further configured for the terminal, so that the terminal may use the configured two aperiodic SRS resource sets accurately.

The disclosure will further be described below in combination with application embodiments in detail.

In an application embodiment, when aperiodic SRSs are used for 1T4R antenna switching, it may be configured that two aperiodic SRS resource sets are triggered by a piece of DCI. In such a manner, the two aperiodic SRS resource sets may be configured to have identical aperiodicSRS-ResourceTrigger parameter values and different slotoffset parameter values.

In another application embodiment, when aperiodic SRSs are used for 1T4R antenna switching, it may be configured that two aperiodic SRS resource sets are triggered by two pieces of DCI, respectively.

Only when higher layer parameters Usage of both the two aperiodic SRS resource sets are set to be antenna switching, the two aperiodic SRS resource sets are used for 1T4R antenna switching.

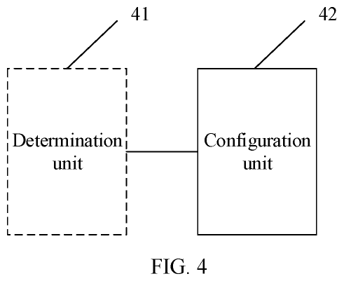

For implementing the method for a network device side in the embodiments of the disclosure, the embodiments of the disclosure also provide an uplink-signal-based processing apparatus, which is arranged in a network device. As illustrated in FIG. 4, the apparatus includes a determination unit 41 and a configuration unit 42.

The determination unit 41 is configured to determine to start antenna switching.

The configuration unit 42 is configured to configure two aperiodic SRS resource sets for antenna switching for a terminal.

In an embodiment, the two aperiodic SRS resource sets include totally four SRS resources, the four SRS resources are transmitted on different OFDM symbols of two different slots, and a SRS port of each SRS resource in the two aperiodic SRS resource sets is associated with a different antenna port of the terminal.

In an implementation, the two aperiodic SRS resource sets may be triggered by a piece of DCI for transmission.

In such case, the configuration unit 42 is further configured to execute at least one of the following operations:

configuring the two aperiodic SRS resource sets with same values of higher layer parameter aperiodicSRS-ResourceTrigger; or

configuring the two aperiodic SRS resource sets with different values of higher layer parameter slotoffset.

In another implementation, the two aperiodic SRS resource sets may be triggered by two pieces of DCI for transmission, respectively.

During a practical application, the numbers of the SRS resources in the two aperiodic SRS resource sets may be configured in the following two manners.

A first manner: each of the two aperiodic SRS resource sets is configured with two SRS resources.

A second manner: one of the two aperiodic SRS resource sets is configured with one SRS resource, and the other of the two aperiodic SRS resource sets is configured with three SRS resources.

After the configuration is completed, the configuration unit 42 may transmit configuration information to the terminal for aperiodic SRS transmission of the terminal.

During the practical application, the determination unit 41 and the configuration unit 42 may be implemented by a processor in the uplink-signal-based processing apparatus in combination with a communication interface.

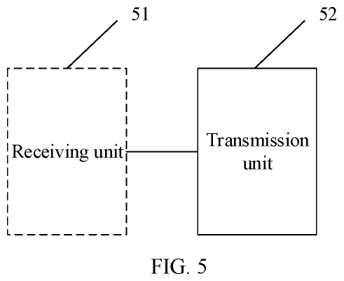

For implementing the method for a terminal side in the embodiments of the disclosure, the embodiments of the disclosure also provide an uplink-signal-based processing apparatus, which is arranged in a terminal. As illustrated in FIG. 5, the apparatus includes a receiving unit 51 and a transmission unit 52.

The receiving unit 51 is configured to receive configuration information from a network device.

The transmission unit 52 is configured to perform antenna switching using two aperiodic SRS resource sets.

That is, the transmission unit 52 performs antenna switching using the configured two aperiodic SRS resource sets.

In an implementation, the two aperiodic SRS resource sets may be triggered by a piece of DCI for transmission.

Based on this, the transmission unit 52 determines that triggered SRS resource sets are the two aperiodic SRS resource sets based on a piece of received DCI.

In such case, during performing antenna switching, the transmission unit 52 is further configured to determine that the triggered SRS resource sets are the two aperiodic SRS resource sets based on at least one of the following:

two same values of higher layer parameter aperiodicSRS-ResourceTrigger; or

two different values of higher layer parameter slotoffset.

In another implementation, the two aperiodic SRS resource sets may be triggered by two pieces of DCI for transmission, respectively.

Based on this, the transmission unit 52 determines that a triggered SRS resource set is one aperiodic SRS resource set in the two aperiodic SRS resource sets based on one piece of DCI in two pieces of received DCI, and determines that another triggered SRS resource set is the other aperiodic SRS resource set in the two aperiodic SRS resource sets based on the other DCI in the two pieces of received DCI.

In an implementation, antenna switching may be 1T4R antenna (four-port antenna) switching. That is, the aperiodic SRSs for antenna switching are aperiodic SRSs for 1T4R antenna switching.

Only when higher layer parameters Usage of both the two aperiodic SRS resource sets are set to be antenna switching, the two aperiodic SRS resource sets are used for four-port antenna switching.

Based on this, the transmission unit 52 is further configured to:

determine that the triggered SRS resource sets are used for four-port antenna switching when higher layer parameters Usage of both the two aperiodic SRS resource sets are set to be antenna switching.

During a practical application, the receiving unit 51 may be implemented by a communication interface in the uplink-signal-based processing apparatus, and the transmission unit 52 may be implemented by a processor in the uplink-signal-based processing apparatus in combination with the communication interface.

It is to be noted that the uplink-signal-based processing apparatus provided in the embodiment is described with division of each of the abovementioned program modules as an example during uplink-signal-based processing, and during the practical application, such processing may be allocated to different program modules for completion according to a requirement, that is, an internal structure of the device is divided into different program modules to complete all or part of abovementioned processing. In addition, the uplink-signal-based processing apparatus provided in the embodiment belongs to the same concept of the uplink-signal-based processing method embodiment and details about a specific implementation process thereof refer to the method embodiment and will not be elaborated herein.

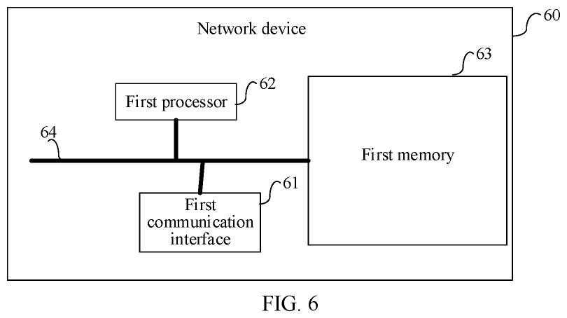

Based on hardware implementation of each program module, for implementing the method for the network device side in the embodiments of the disclosure, the embodiments of the disclosure also provide a network device. As illustrated in FIG. 6, the network device 60 includes a first communication interface 61 and a first processor 62.

The first communication interface 61 may perform information interaction with a terminal.

The first processor 62 is connected with the first communication interface 61 to implement information interaction with the terminal, and is configured to run a computer program to execute the method provided in one or more abovementioned technical solutions. The computer program is stored in a first memory 63.

Specifically, the first processor 62 is configured to, through the first communication interface 61, configure two aperiodic SRS resource sets for antenna switching for the terminal.

During a practical application, the first processor 62, in response to determining to start antenna switching, may configure, through the first communication interface 61, the two aperiodic SRS resource sets for antenna switching for the terminal.

In an implementation, the two aperiodic SRS resource sets may be triggered by a piece of DCI for transmission.

In such case, the first processor 62 is further configured to execute, through the first communication interface 61, at least one of the following operations:

configuring the two aperiodic SRS resource sets with same values of higher layer parameter aperiodicSRS-ResourceTrigger; or

configuring the two aperiodic SRS resource sets with different values of higher layer parameter slotoffset.

In another implementation, the two aperiodic SRS resource sets may be triggered by two pieces of DCI for transmission, respectively.

During the practical application, the numbers of the SRS resources in the two aperiodic SRS resource sets may be configured in the following two manners.

A first manner: the first processor 62 configures each of the two aperiodic SRS resource sets with two SRS resources.

A second manner: the first processor 62 configures one of the two aperiodic SRS resource sets with one SRS resource and configures the other aperiodic SRS resource set in the two aperiodic SRS resource sets with three SRS resources.

Of course, during the practical application, as illustrated in FIG. 6, various components in the network device 60 are coupled together through a bus system 64. It is to be understood that the bus system 64 is configured to implement connections and communications between these components. The bus system 64 includes a power bus, a control bus and a status signal bus in addition to a data bus. However, for clear description, various buses in FIG. 6 are marked as the bus system 64.

In the embodiment of the disclosure, the first memory 63 is configured to store various types of data to support the operations of the network device 60.

The method disclosed in the embodiments of the disclosure may be applied to the first processor 62 or implemented by the first processor 62. The first processor 62 may be an integrated circuit chip with a signal processing capability. In an implementation process, steps of the method may be completed by an integrated logic circuit of hardware in the first processor 62 or instructions in a software form. The first processor 62 may be a universal processor, a digital signal processor (DSP) or another programmable logic device (PLD), a discrete gate or transistor logic device, a discrete hardware component and the like. The first processor 62 may implement or execute each method, step and logical block diagram disclosed in the embodiments of the disclosure. The universal processor may be a microprocessor, any conventional processor or the like. The steps of the method disclosed in combination with the embodiments of the disclosure may be directly embodied to be executed and completed by a hardware decoding processor or executed and completed by a combination of hardware and software modules in the decoding processor. The software module may be in a storage medium, and the storage medium is in the first memory 63. The first processor 62 reads information from the first memory 63 and completes the steps of the method in combination with hardware.

In an exemplary embodiment, the network device 60 may be implemented by one or more application specific integrated circuits (ASICs), DSPs, PLDs, complex programmable logic devices (CPLDs), field-programmable gate arrays (FPGAs), universal processors, controllers, micro controller units (MCUs), microprocessors or other electronic components, and is configured to execute the abovementioned method.

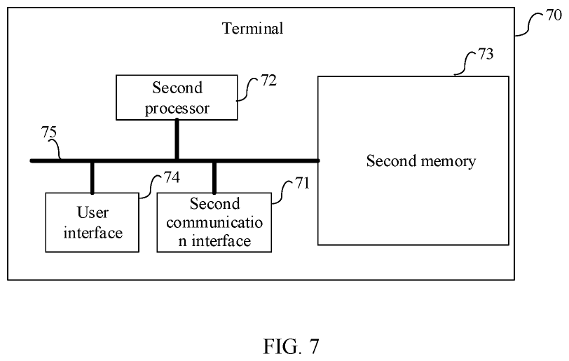

Based on hardware implementation of each program module, for implementing the method for the terminal side in the embodiments of the disclosure, the embodiments of the disclosure also provide a terminal. As illustrated in FIG. 7, the terminal 70 includes a second communication interface 71 and a second processor 72.

The second communication interface 71 is configured to perform information interaction with a network device.

The second processor 72 is connected with the second communication interface 71 to implement information interaction with the network device, and is configured to run a computer program to execute the method provided in one or more abovementioned technical solutions. The computer program is stored in a second memory 73.

Specifically, the second processor 72 is configured to perform, through the second communication interface 71, antenna switching using two aperiodic SRS resource sets.

That is, aperiodic SRSs for antenna switching are transmitted using the two aperiodic SRS resource sets.

In an implementation, the two aperiodic SRS resource sets may be triggered by a piece of DCI for transmission.

Based on this, the second processor 72 determines that triggered SRS resource sets are the two aperiodic SRS resource sets based on a piece of DCI received through the second communication interface 71.

In such case, the second processor 72 is further configured to determine that the triggered SRS resource sets are the two aperiodic SRS resource sets based on at least one of the following:

two same values of higher layer parameter aperiodicSRS-ResourceTrigger; or

two different values of higher layer parameter slotoffset.

In another implementation, the two aperiodic SRS resource sets may be triggered by two pieces of DCI for transmission respectively.

Based on this, the second processor 72 determines that a triggered SRS resource set is one aperiodic SRS resource set in the two aperiodic SRS resource sets based on one piece of DCI in two pieces of DCI received through the second communication interface 71 and determines that another triggered SRS resource set is the other aperiodic SRS resource set in the two aperiodic SRS resource sets based on the other DCI in the two pieces of received DCI.

In an implementation, antenna switching may be 1T4R antenna (four-port antenna) switching. That is, the aperiodic SRSs for antenna switching are aperiodic SRSs for 1T4R antenna switching.

Only when higher layer parameters Usage of both the two aperiodic SRS resource sets are set to be antenna switching, the two aperiodic SRS resource sets are configured for four-port antenna switching.

Based on this, the second processor 72 is further configured to:

when higher layer parameters Usage of both the two aperiodic SRS resource sets are set to be antenna switching, determine that the triggered aperiodic SRS resource sets are configured for four-port antenna switching.

Of course, during a practical application, the terminal 70 may further include a user interface 74. Various components in the terminal 70 are coupled together through a bus system 75. It is to be understood that the bus system 75 is configured to implement connections and communications between these components. The bus system 75 includes a power bus, a control bus and a status signal bus in addition to a data bus. However, for clear description, various buses in FIG. 7 are marked as the bus system 75.

The user interface 74 may include a display, a keyboard, a mouse, a trackball, a click wheel, a key, a button, a touch pad or a touch screen, etc.

In the embodiment of the disclosure, the second memory 73 is configured to store various types of data to support the operations of the terminal 70.

The method disclosed in the embodiments of the disclosure may be applied to the second processor 72 or implemented by the second processor 72. The second processor 72 may be an integrated circuit chip with a signal processing capability. In an implementation process, steps of the method may be completed by an integrated logic circuit of hardware in the second processor 72 or instructions in a software form. The second processor 72 may be a universal processor, a DSP or another PLD, a discrete gate or transistor logic device, a discrete hardware component and the like. The second processor 72 may implement or execute each method, step and logical block diagram disclosed in the embodiments of the disclosure. The universal processor may be a microprocessor, any conventional processor or the like. The steps of the method disclosed in combination with the embodiments of the disclosure may be directly embodied to be executed and completed by a hardware decoding processor or executed and completed by a combination of hardware and software modules in the decoding processor. The software module may be in a storage medium, and the storage medium is in the second memory 73. The second processor 72 reads information from the second memory 73 and completes the steps of the method in combination with hardware.

In an exemplary embodiment, the terminal 70 may be implemented by one or more ASICs, DSPs, PLDs, CPLDs, FPGAs, universal processors, controllers, MCUs, microprocessors or other electronic components, and is configured to execute the abovementioned method.

It can be understood that specific implementation of the processor in the embodiments of the disclosure may be understood with reference to the abovementioned method.

The memory (for example, the first memory 63 and the second memory 73) in the embodiments of the disclosure may be a volatile memory or a nonvolatile memory, and may also include both the volatile and nonvolatile memories. The nonvolatile memory may be a read only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, a compact disc or a compact disc read-only memory (CD-ROM). The magnetic surface memory may be a disk memory or a tape memory. The volatile memory may be a random access memory (RAM), and is used as an external high-speed cache. It is exemplarily but unlimitedly described that RAMs in various forms may be adopted, such as a static random access memory (SRAM), a synchronous static random access memory (SSRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synclink dynamic random access memory (SLDRAM) and a direct rambus random access memory (DRRAM). The memory described in the embodiments of the disclosure is intended to include, but not limited to, memories of these and any other proper types.

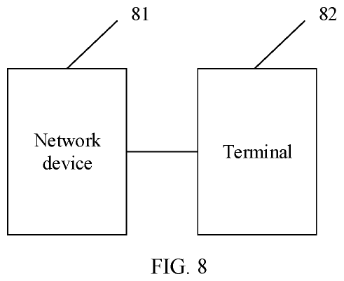

For implementing the method of the embodiments of the disclosure, the embodiments of the disclosure also provide an uplink-signal-based processing system. As illustrated in FIG. 8, the system includes a network device 81 and a terminal 82.

The network device 81 is configured to configure two aperiodic SRS resource sets for antenna switching for the terminal 82.

The terminal 82 is configured to perform antenna switching using the two aperiodic SRS resource sets.

It is to be noted that specific processing processes of the network device 81 and the terminal 82 are elaborated above and will not be elaborated herein.

In an exemplary embodiment, the embodiments of the disclosure also provide a storage medium, which may specifically be a computer-readable storage medium, for example, a first memory 63 including a computer program, the computer program being executed by a first processor 62 of a network device 60 to complete the steps of the method for the network device side, or a second memory 73 including a computer program, the computer program being executed by a second processor 72 of a terminal 70 to complete the steps of the method for the terminal side.

The computer-readable storage medium may be a memory such as an FRAM, a ROM, a PROM, an EPROM, an EEPROM, a flash memory, a magnetic surface memory, a compact disc or a CD-ROM.

It is to be noted that “first”, “second” and the like are adopted to distinguish similar objects and not intended to describe a specific sequence or order.

In addition, the technical solutions recorded in the embodiments of the disclosure may be freely combined without conflicts.

The above is only the preferred embodiment of the disclosure and not intended to limit the scope of protection of the disclosure.

1. An uplink-signal-based processing method, implemented by a network device, the method comprising:
configuring for a terminal two aperiodic sounding reference signal (SRS) resource sets for antenna switching,
wherein, during configuring the two aperiodic SRS resource sets, the method further comprises at least one of:
configuring the two aperiodic SRS resource sets with same values of higher layer parameter aperiodicSRS-ResourceTrigger; or
configuring the two aperiodic SRS resource sets with different values of higher layer parameter slotoffset.

2. The uplink-signal-based processing method of claim 1, wherein
the two aperiodic SRS resource sets comprise a total of four SRS resources, the four SRS resources are transmitted in different orthogonal frequency division multiplexing (OFDM) symbols of two different slots, a SRS port of each SRS resource in the two aperiodic SRS resource sets being associated with a different antenna port of the terminal.

3. (canceled)

4. The uplink-signal-based processing method of claim 1, wherein the two aperiodic SRS resource sets are triggered by a piece of downlink control information (DCI).

5. The uplink-signal-based processing method of claim 1, wherein the two aperiodic SRS resource sets are triggered by two pieces of DCI, respectively.

6. The uplink-signal-based processing method of claim 1, wherein, during configuring the two aperiodic SRS resource sets, the method further comprises:
configuring each of the two aperiodic SRS resource sets with two SRS resources.

7. The uplink-signal-based processing method of claim 1, wherein, during configuring the two aperiodic SRS resource sets, the method further comprises:
configuring one of the two aperiodic SRS resource sets with one SRS resource, and configuring the other of the two aperiodic SRS resource sets with three SRS resources.

8. The uplink-signal-based processing method of claim 1, wherein
when higher layer parameters Usage of both the two aperiodic SRS resource sets are set to be antenna switching, the two aperiodic SRS resource sets are used for four-port antenna switching.

9. An uplink-signal-based processing method, applied to a terminal, the method comprising:
performing antenna switching using two aperiodic sounding reference signal (SRS) resource sets configured by a network device,
wherein the two aperiodic SRS resource sets are configured with at least one of:
two same values of higher layer parameter aperiodicSRS-ResourceTrigger; or
two different values of higher layer parameter slotoffset.

10. (canceled)

11. The uplink-signal-based processing method of claim 9, further comprising: determining that triggered SRS resource sets are the two aperiodic SRS resource sets based on a piece of received downlink control information (DCI).

12. The uplink-signal-based processing method of claim 9, further comprising: determining that a triggered SRS resource set is one of the two aperiodic SRS resource sets based on one piece of DCI in two pieces of received DCI, and determining that another triggered SRS resource set is the other aperiodic SRS resource set in the two aperiodic SRS resource sets based on the other DCI in the two pieces of received DCI.

13. The uplink-signal-based processing method of claim 9, wherein when higher layer parameters Usage of the two aperiodic SRS resource sets are set to be antenna switching, determining that triggered aperiodic SRS resource sets are configured for four-port antenna switching.

14.-20. (canceled)

21. A network device, comprising:
a first communication interface; and
a first processor, configured to, through the first communication interface, configure for a terminal two aperiodic sounding reference signal (SRS) resource sets for antenna switching,
wherein the first processor is further configured to execute, through the first communication interface, at least one of the following operations:
configuring the two aperiodic SRS resource sets with same values of higher layer parameter aperiodicSRS-ResourceTrigger; or
configuring the two aperiodic SRS resource sets with different values of higher layer parameter slotoffset.

22. (canceled)

23. The device of claim 21, wherein the first processor is further configured to, through the first communication interface, configure each of the two aperiodic SRS resource sets with two SRS resources.

24. The device of claim 21, wherein the first processor is further configured to: through the first communication interface, configure one of the two aperiodic SRS resource sets with one SRS resource and configure the other of the two aperiodic SRS resource sets with three SRS resources.

25. A terminal, comprising:
a second communication interface; and
a second processor, configured to perform, through the second communication interface, antenna switching using two aperiodic sounding reference signal (SRS) resource sets configured by a network device,
wherein the second processor is further configured to determine that triggered SRS resource sets are the two aperiodic SRS resource sets based on at least one of the following:
two same values of higher layer parameter aperiodicSRS-ResourceTrigger; or
two different values of higher layer parameter slotoffset.

26. (canceled)

27. The terminal of claim 25, wherein the second processor is further configured to:
when higher layer parameters Usage of both the two aperiodic SRS resource sets are set to be antenna switching, determine that triggered aperiodic SRS resource sets are configured for four-port antenna switching.

28.-30. (canceled)

31. The network device of claim 21, wherein the two aperiodic SRS resource sets are triggered by a piece of downlink control information (DCI).

32. The network device of claim 21, wherein the two aperiodic SRS resource sets are triggered by two pieces of DCI, respectively.

33. The terminal of claim 25, wherein the second processor is further configured to:
determine that triggered SRS resource sets are the two aperiodic SRS resource sets based on a piece of received downlink control information (DCI).

34. The terminal of claim 25, wherein the second processor is further configured to:
determine that a triggered SRS resource set is one of the two aperiodic SRS resource sets based on one piece of DCI in two pieces of received DCI, and determine that another triggered SRS resource set is the other aperiodic SRS resource set in the two aperiodic SRS resource sets based on the other DCI in the two pieces of received DCI.
